(19) United States
(12) Patent Application Publication
(10) Pub. No.: US 2015/0364141 A1
(43) Pub. Date: Dec. 17, 2015

(54) METHOD AND DEVICE FOR PROVIDING USER INTERFACE USING VOICE RECOGNITION

(71) Applicant: SAMSUNG ELECTRONICS CO., LTD., Suwon-si (KR)

(72) Inventors: Ho-Sub LEE, Seoul (KR); Young Sang CHOI, Seongnam-si (KR)

(73) Assignee: SAMSUNG ELECTRONICS CO., LTD., Suwon-si (KR)

(21) Appl. No.: 14/612,325

(22) Filed: Feb. 3, 2015

(30) Foreign Application Priority Data
Jun. 16, 2014 (KR) 10-2014-0072624

(51) Int. Cl. G10L 15/26; G06F 3/0481; G06F 17/24; G10L 17/22; G06F 3/16

(52) U.S. Cl. CPC G10L 15/26; G10L 17/22; G06F 3/167; G06F 17/24; G06F 3/0481

(57) ABSTRACT

A method of providing a user interface (UI), includes generating first feature information indicating a feature of a voice signal, and converting the voice signal to a first text. The method further includes visually changing the first text based on the first feature information, and providing the UI displaying the changed first text.

### CROSS-REFERENCE TO RELATED APPLICATION

This application claims the benefit under 35 USC 119(a) of Korean Patent Application No. 10-2014-0072624, filed on Jun. 16, 2014, in the Korean Intellectual Property Office, the entire disclosure of which is incorporated herein by reference for all purposes.

### BACKGROUND

1. Field

The following description relates to a method and a device for providing a user interface (UI).

2. Description of Related Art

Voice recognition technology is gaining increased prominence with the development of smartphones and intelligent software. Such growth of the voice recognition technology is attributed to a wide range of applications, for example, device controlling, Internet searches, dictation of memos and messages, and language learning.

However, existing voice recognition technology still remains at a level of using a user interface (UI) that simply provides a result obtained through voice recognition. Thus, a user may not easily verify whether a word is pronounced accurately or the user has a stammer.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a method of providing a user interface (UI), including generating first feature information indicating a feature of a voice signal, converting the voice signal to a first text, visually changing the first text based on the first feature information, and providing the UI displaying the changed first text.

The first feature information may include accuracy information of a word in the voice signal, and the visually changing may include changing a color of the first text based on the accuracy information.

The first feature information may include accent information of a word in the voice signal, and the visually changing may include changing a thickness of the first text based on the accent information.

The first feature information may include intonation information of a word in the voice signal, and the visually changing may include changing a position at which the first text is displayed based on the intonation information.

The first feature information may include length information of a word in the voice signal, and the visually changing may includes changing a spacing of the first text based on the length information.

The method may further include segmenting the voice signal based on any one unit of a phoneme, a syllable, a word, a phrase, and a sentence. The generating may include generating first feature information indicating a feature of a voice signal obtained by the segmenting, and the converting may include converting the voice signal obtained by the segmenting to a first text.

The method may further include generating a statistical feature of the first text based on the first feature information and the first text. The providing may include providing the UI displaying the statistical feature and the changed first text.

The method may further include generating second feature information indicating a feature of a reference voice signal corresponding to the voice signal, converting the reference voice signal to a second text, visually changing the second text based on the second feature information, and providing another UI displaying the changed second text.

The method may further include detecting an action corresponding to all or a portion of the first text, and reproducing a voice signal or a reference voice signal of a first text corresponding to the detected action.

In another general aspect, there is provided a method of providing a user interface (UI), including segmenting a voice signal into elements, generating sets of feature information on the elements, converting the elements to texts, extracting one or more stammered words from the texts by determining whether the sets of the feature information are repeatedly detected within a preset range, determining whether a user has a stammer based on a number of the stammered words, and providing the UI displaying a result of the determining.

The extracting may include extracting, as the one or more stammered words, a text corresponding to the sets of feature information repeatedly detected within the preset range.

The determining of whether the user has a stammer may include determining whether the user has a stammer based on a ratio of the number of the stammered words to a number of the texts.

In still another general aspect, there is provided a device for providing a user interface (UI), including a voice recognizer configured to generate first feature information indicating a feature of a voice signal, and convert the voice signal to a first text, a UI configurer configured to visually change the first text based on the first feature information, and a UI provider configured to provide the UI displaying the changed first text.

The first feature information may include accuracy information of a word in the voice signal, and the UI configurer may be configured to change a color of the first text based on the accuracy information.

The first feature information may include accent information of a word in the voice signal, and the UI configurer may be configured to change a thickness of the first text based on the accent information.

The first feature information may include intonation information of a word in the voice signal, and the UI configurer may be configured to change a position at which the first text is displayed based on the intonation information.

The first feature information may include length information of a word in the voice signal, and the UI configurer may be configured to change a spacing of the first text based on the length information.

The voice recognizer may be configured to segment the voice signal based on any one unit of a phoneme, a syllable, a word, a phrase, and a sentence, generate first feature information indicating a feature of a voice signal obtained by the segmenting, and convert the voice signal obtained by the segmenting to a first text.

The voice recognizer may be configured to generate a statistical feature of the first text based on the first feature information and the first text, and the UI provider may be configured to provide the UI displaying the statistical feature and the changed first text.

The voice recognizer may be configured to generate second feature information indicating a feature of a reference voice signal corresponding to the voice signal, and convert the reference voice signal to a second text, the UI configurer may be configured to visually change the second text based on the second feature information, and the UI provider may be configured to provide another UI displaying the changed second text.

In yet another general aspect, there is provided a device for providing a user interface (UI), including a UI configurer configured to visually change a text converted from a voice signal based on a feature of the voice signal, and a UI provider configured to provide the UI displaying the changed text.

The feature may include an accuracy, an accent, an intonation, or a length of a word in the voice signal.

The UI provider may be configured to provide the UI displaying the changed text and a value of the feature.

Other features and aspects will be apparent from the following detailed description, the drawings, and the claims.

### BRIEF DESCRIPTION OF THE DRAWINGS

FIG. 1 is a diagram illustrating an example of a device for providing a user interface (UI).

FIG. 2 is a diagram illustrating an example of configuring a UI.

FIG. 3 is a diagram illustrating an example of providing a UI.

FIG. 4 is a flowchart illustrating an example of a method of providing a UI.

FIG. 5 is a flowchart illustrating another example of a method of providing a UI.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

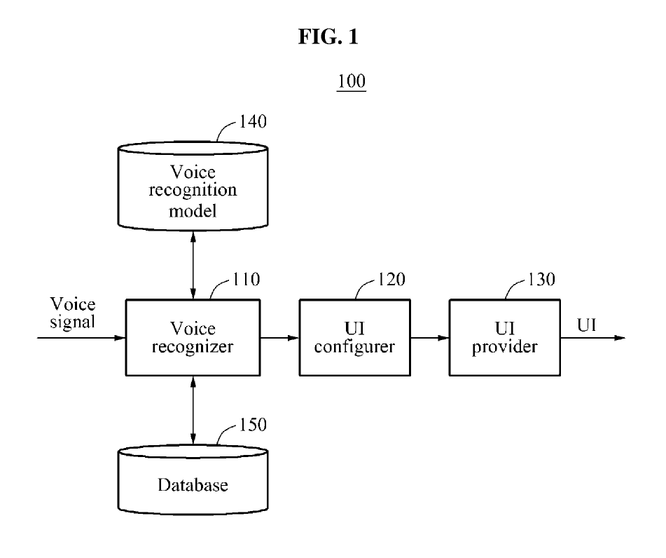

FIG. 1 is a diagram illustrating an example of a device 100 for providing a user interface (UI). Referring to FIG. 1, the device 100 includes a voice recognizer 110, a UI configurer 120, and a UI provider 130. The device 100 further includes a voice recognition model 140 and a database 150.

The voice recognizer 110 receives a voice signal from a user through an inputter, for example, a microphone. The voice recognizer 110 performs voice recognition, using a voice recognition engine. The voice recognizer 110 generates feature information indicating a feature of the voice signal, using the voice recognition engine, and converts the voice signal to a text. For example, the voice recognition engine may be designed as software based on a machine learning algorithm, for example, recurrent deep neural networks.

The voice recognizer 110 converts the voice signal to a feature vector. The voice recognizer 110 segments the voice signal based on any one unit of a phoneme, a syllable, a word, a phrase, and a sentence, and converts voice signals obtained by the segmenting to corresponding feature vectors. For example, a feature vector may have a form of mel-frequency cepstral coefficients (MFCCs).

In an example, the voice recognizer 110 determines which unit among the phoneme, the syllable, the word, the phrase, and the sentence is used to process the voice signal based on a level of noise included in the voice signal. The voice recognizer 110 may process the voice signal by segmenting the voice signal into smaller units when the level of noise included in the voice signal increases. Alternatively, the voice recognizer 110 may process the voice signal with a unit predetermined by the user.

The voice recognizer 110 generates the feature information indicating the feature of the voice signal, using the feature vector. For example, the feature information may include at least one set of accuracy information, accent information, intonation information, and length information of a pronounced word included in the voice signal. However, the feature information may not be limited thereto, and further include information indicating any feature of the pronounced word.

In such an example, the accuracy information may indicate how accurately the user pronounces a word. The accuracy information may have a value within a range between 0 and 1.

The accent information may indicate whether an accent is present on the pronounced word. The accent information may have any one value between “true” and “false.” For example, when the accent is present on the pronounced word, the accent information may have a value of true. Conversely, when the accent is absent from the pronounced word, the accent information may have a value of false.

The intonation information may indicate a pitch of the pronounced word, and have a value proportionate to an amplitude of the voice signal.

The length information may indicate a value proportionate to a duration utilized for conveying the pronounced word.

The voice recognizer 110 converts the voice signal to the text. For example, the voice recognizer 110 converts the voice signal to the text, using the feature vector converted from the voice signal and the voice recognition model 140. The voice recognizer 110 compares the feature vector converted from the voice signal to a reference feature vector stored in the voice recognition model 140, and selects a reference feature vector most similar to the feature vector converted from the voice signal. The voice recognizer 110 converts the voice signal to a text corresponding to the selected reference feature vector. Concisely, the voice recognizer 110 converts the voice signal to a text having a greatest probabilistic match to the voice signal.

The voice recognition model 140 may be a database used to convert a voice signal to a text, and include numerous reference feature vectors and texts corresponding to the reference feature vectors. The voice recognition model 140 may include a large quantity of sample data to be used to map the reference feature vectors and the texts.

For example, the voice recognition model 140 may be included in the device 100, or alternatively in a server located externally from the device 100. When the voice recognition model 140 is included in the server located externally from the device 100, the device 100 may transmit the feature vector converted from the voice signal to the server, and receive the text corresponding to the voice signal from the server. Further, the voice recognition model 140 may additionally include new sample data, or delete a portion of existing sample data by performing an update.

The voice recognizer 110 stores the feature information and the text in the database 150. The voice recognizer 110 further stores, in the database 150, information of an environment, for example, a level of noise, when the voice signal is received from the user.

The voice recognizer 110 generates a statistical feature of the text based on at least one set of the feature information and the text stored in the database 150. In an example, the statistical feature may include accuracy information, accent information, intonation information, and length information of a word pronounced by the user. In such an example, when the user pronounces “boy,” the statistical feature may indicate that “boy” pronounced by the user has, on average, an accuracy information value of 0.95, an accent information value of true, an intonation information value of 2.5, and a length information value of 0.2.

The UI configurer 120 configures a UI by visually changing the text based on the feature information. The UI configurer 120 configures the UI by visually changing a color, a thickness, a display position, and/or a spacing of the text based on the feature information.

The UI configurer 120 may change the color of the text based on the accuracy information of the pronounced word. For example, the UI configurer 120 may set a section or range of the accuracy information, and change a color of a first text to correspond to the section. When the accuracy information has a value within a range between 0.9 and 1.0, the UI configurer 120 may change the color of the text to green. When the accuracy information has a value within a range between 0.8 and 0.9, the UI configurer 120 may change the color of the text to yellow. When the accuracy information has a value within a range between 0.7 and 0.8, the UI configurer 120 may change the color of the text to orange. Also, when the accuracy information has a value less than or equal to 0.7, the UI configurer 120 may change the color of the text to red. However, the color of the text may not be limited thereto, and various methods may be applied to change the color.

The UI configurer 120 may change the thickness of the text based on the accent information pertaining to the pronounced word. When the accent information has a value of true, the UI configurer 120 may set the thickness of the text to be thick. Conversely, when the accent information has a value of false, the UI configurer 120 may not set the thickness of the text to be thick.

In addition, the UI configurer 120 may change the display position at which the text is displayed based on the intonation information. When a value of the intonation information increases, the UI configurer 120 changes the display position of the text to be high. Conversely, when the value of the intonation information decreases, the UI configurer 120 changes the display position of the text to be low.

Further, the UI configurer 120 may change the spacing of the text based on the length information. When a value of the length information increases, the UI configurer 120 may the spacing of the first text to be broad. For example, when the user pronounces “boy” longer, the UI configurer 120 may change the spacing of the text to be broader than when the user pronounces “boy” shorter.

The UI provider 130 provides the UI configured by the UI configurer 120 to the user. The UI provider 130 provides the UI displaying the visually changed text to the user. In addition, the UI provider 130 provides, to the user, the UI displaying the statistical feature corresponding to the visually changed text along with the changed text. Further, the UI provider 130 provides the UI reproducing the voice signal to the user.

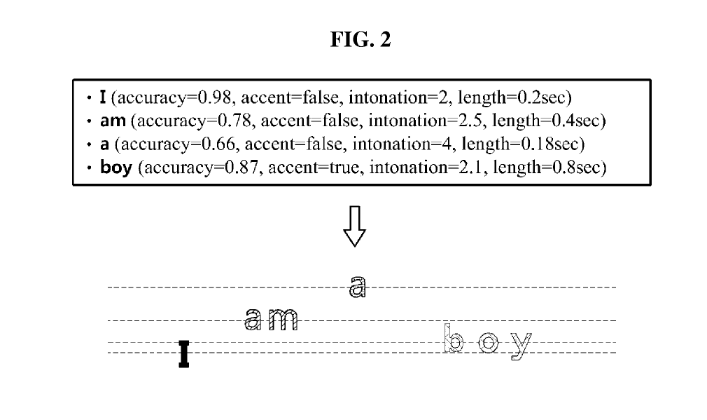

FIG. 2 is a diagram illustrating an example of configuring a UI. Referring to FIG. 2, when a user pronounces a sentence “I am a boy,” a device for providing the UI operates as follows. The device segments the sentence “I am a boy” into a unit of a word, for example, “I,” “am,” “a,” and “boy.” The device generates sets of feature information indicating respective features of voice signals segmented into “I,” “am,” “a,” and “boy.” The device converts the voice signals segmented into “I,” “am,” “a,” and “boy” to respective texts.

For example, the device converts a voice signal “boy” to a feature vector, using a voice recognition engine. The device generates feature information of the voice signal “boy,” using a voice recognition model, and the feature vector corresponding to the voice signal “boy,” and converts the voice signal “boy” to a text.

For example, first feature information on the voice signal “boy” includes accuracy information having a value of 0.87, accent information having a value of true, intonation information having a value of 2.1, and length information having a value of 0.8. Feature information of the remaining voice signals “I,” “am,” and “a,” excluding the voice signal “boy,” is illustrated in FIG. 2.

The device visually changes the texts based on the sets of feature information. As illustrated in FIG. 2, the text “boy” may be displayed in yellow to correspond to the accuracy information having the value of 0.87, and is to be thick to correspond to the accent information having the value of true. In addition, the text “boy” is displayed at a height corresponding to the intonation information having the value of 2.1, and has a spacing corresponding to the length information having the value of 0.8.

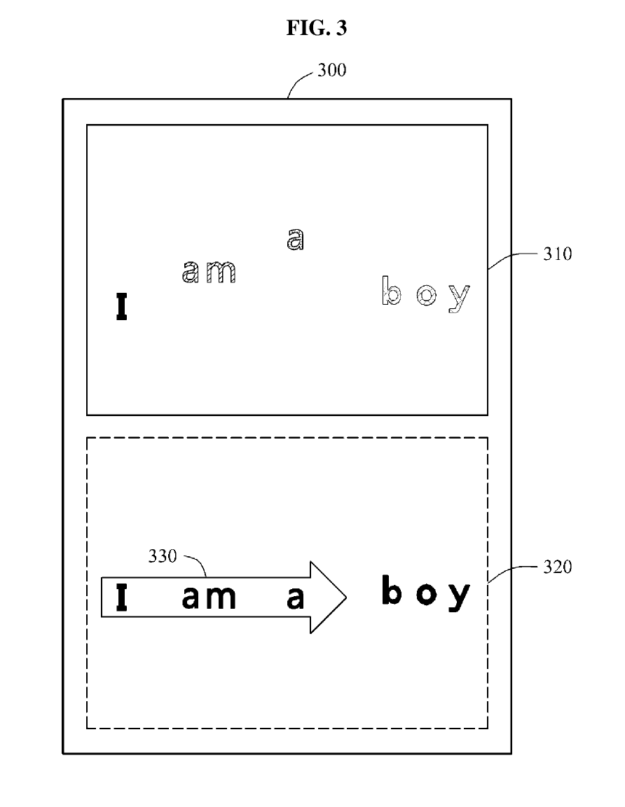

FIG. 3 is a diagram illustrating an example of providing a UI. For convenience of description, feature information of a voice signal received from a user will be hereinafter referred to as “first feature information,” and a text converted from the voice signal will be hereinafter referred to as “first text.” In addition, description feature information of a reference voice signal corresponding to the voice signal will be hereinafter referred to as “second feature information,” and a text converted from the reference voice signal will be hereinafter referred to as “second text.”

A UI 310 displays a result of visually changing the first text based on the first feature information of the voice signal received from the user. A device 300 for providing a UI detects an action of the user that requests additional information from the user. The action of the user requesting the additional information may include, for example, touching, successive touching, and/or voice input. For example, the additional information may include at least one of a visually changed second text based on the second feature information, reproduction of the voice signal or the reference voice signal, and a statistical feature of the first text.

In an example, the user may additionally request a UI 320 displaying the visually changed second text based on the second feature information by touching a portion of a display. In such an example, the device 300 reads the reference voice signal corresponding to the voice signal from a voice recognition model. The device 300 generates the second feature information of the reference voice signal, and converts the reference voice signal to the second text. In addition, the device 300 configures the UI 320 displaying a result of visually changing the second text based on the second feature information. Thus, the device 300 provides the UI 320 displaying the visually changed second text along with the UI 310 displaying the visually changed first text.

In another example, the user may request for the reproduction of the voice signal or the reference voice signal by touching or successively touching at least a portion of displayed texts. For example, as indicated in 330, the user successively touches at least a portion of the displayed second text. The device 300 identifies a portion, for example, “I am a,” of the second text that corresponds to the successive touching performed by the user. Thus, the device 300 provides the UI 320 reproducing a reference voice signal corresponding to the portion “I am a” of the second text. When the user touches or successively touches at least a portion of the displayed first text, the device 300 provides the UI 310 providing a voice signal corresponding to the touched or the successively touched first text.

In still another example, the user may request statistical features of a touched or successively touched text by touching or successively touching at least a portion of the displayed texts. For example, when the user touches a portion “boy” of the displayed first text, the device 300 provides the UI 310 displaying statistical features of the portion “boy” of the first text along with the visually changed portion “boy” of the first text.

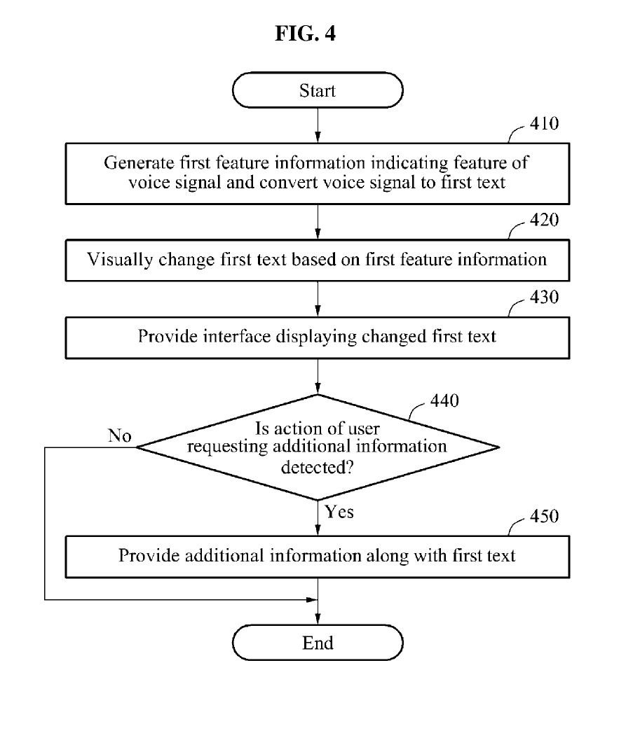

FIG. 4 is a flowchart illustrating an example of a method of providing a UI. The method of providing the UI to be described with reference to FIG. 4 may be performed by a device for providing the UI described herein.

Referring to FIG. 4, in operation 410, the device generates first feature information indicating a feature of a voice signal, and converts the voice signal to a first text. For example, the first feature information may include at least one of accuracy information, accent information, intonation information, and length information of a pronounced word included in the voice signal. However, the first feature information may not be limited thereto, and further include information indicating other features of the pronounced word.

In operation 420, the device visually changes the first text based on the first feature information. For example, the device may a color of the first text based on the accuracy information. The device may change a thickness of the first text based on the accent information. The device may change a display position of the first text at which the first text is displayed, based on the intonation information. In addition, the device may change a spacing of the first text based on the length information.

In operation 430, the device provides a UI displaying the changed first text.

In operation 440, the device determines whether an action of a user requesting additional information is detected. The action of the user may include, for example, touching, successive touching, and/or voice input. When the action of the user is not detected, the device does not provide an additional UI. When the action of the user is detected, the device continues to operation 450.

In operation 450, the device provides the additional information along with the UI displaying the changed first text. For example, the device may additionally display a result of visually changing a second text converted from a reference voice signal, based on second feature information of the reference voice signal corresponding to the voice signal. The device may identify the first text or the second text corresponding to the action of the user, and additionally reproduce a voice signal or a reference voice signal corresponding to the identified first text or the second text. Further, the device may identify the first text corresponding to the action of the user, and additionally provide a statistical feature of the identified first text.

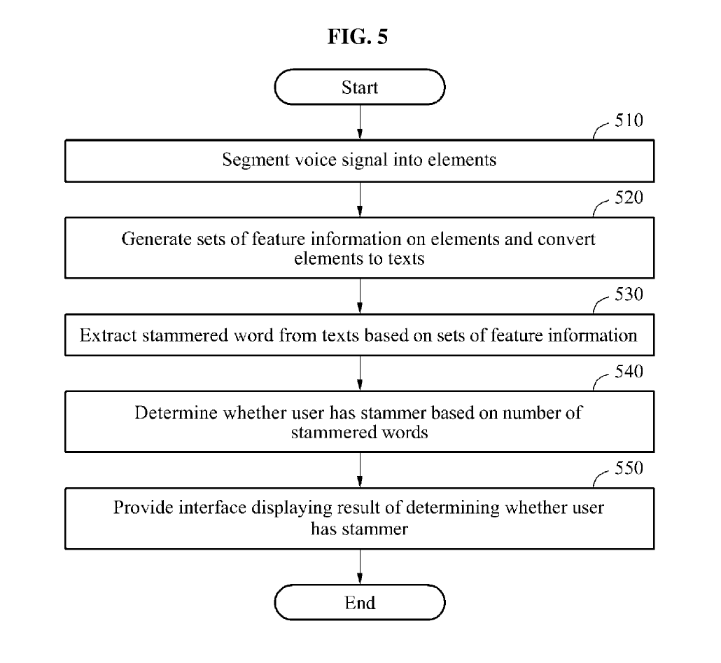

FIG. 5 is a flowchart illustrating another example of a method of providing a UI. The method of providing the UI to be described with reference to FIG. 5 may be performed by a device for providing the UI described herein.

Referring to FIG. 5, in operation 510, the device segments a voice signal received from a user into elements. The elements may refer to voice signals obtained by segmenting the voice signal based on any one unit of a phoneme, a syllable, a word, a phrase, and a sentence. For example, the device may determine a unit of an element based on a repetitive pattern of a waveform included in the voice signal.

In operation 520, the device generates sets of feature information on the elements, and converts the elements to texts. The device converts the elements to respective feature vectors, using a voice recognition engine. The device generates respective sets of feature information of the elements, using the feature vectors.

For example, the feature information may include at least one of accuracy information, accent information, intonation information, and length information of a pronounced word included in the voice signal. However, the feature information may not be limited thereto, and further include information indicating other features of the pronounced word.

The device converts the elements to the texts, using the feature vectors converted from the elements and the voice recognition model. For example, the device compares a feature vector converted from the voice signal to a reference feature vector stored in the voice recognition model, and selects a reference feature vector most similar to the feature vector converted from the voice signal. The device converts the voice signal to a text corresponding to the selected reference feature vector.

In operation 530, the device extracts a stammered word from the texts based on the sets of feature information. For example, the device extracts, as the stammered word, a text corresponding to sets of feature information repeatedly detected within a preset range.

The preset range may indicate a range of reference values used to determine whether the repeatedly detected sets of feature information are similar to one another, and be determined by the user in advance, using various methods. The preset range may be differently set based on detailed items included in the feature information. In addition, the preset range may be set only for at least a portion of the detailed items in the feature information.

For example, “school” having an accuracy information value of 0.8, an accent information value of true, an intonation information value of 2, and a length information value of 0.2, “school” having an accuracy information value of 0.78, an accent information value of true, an intonation information value of 2.1, and a length information value of 0.18, and “school” having an accuracy information value of 0.82, an accent information value of true, an intonation information value of 1.9, and a length information value of 0.21 may be successively and repeatedly input to the device. In such an example, an average value of the accuracy information values is 0.8, and each set of the accuracy information is included within a range of 10% from the average value of 0.8. Each set of the accent information has the value of true. In addition, each set of the intonation information and the length information is included within a range of 10%. Thus, the device extracts “school” as the stammered word.

In operation 540, the device determines whether the user has a stammer based on a number of stammered words. The device determines whether the user has a stammer based on a ratio of the number of stammered words to a number of the texts converted from the elements. For example, when the number of stammered words is greater than 10% of the total number of texts converted from the elements, the device may determine that the user has a stammer. In such an example, the ratio may not be limited to 10%, but set as any of various values by the user.

In operation 550, the device provides a UI displaying a result of the determining of whether the user has a stammer. For example, the device provides a UI displaying whether the user has a stammer. In addition, the device provides a UI displaying a result of visually changing the stammered word.

The device provides, to a predetermined user, the result of the determining of whether the user has a stammer. The predetermined user may include a user inputting the voice signal, a family member of the user, a supporter of the user, and/or a medical staff.

In addition, when an action requesting additional information is detected from the user, the device further provides the additional information to the user. The additional information may include, for example, the ratio of the stammered words to the number of the texts converted from the elements, and reproduction of a voice signal or a reference voice signal corresponding to the stammered word.

Descriptions provided with reference to FIGS. 1 through 4 may be applied to operations described with reference to FIG. 5, and thus, repeated descriptions will be omitted here for brevity.

The examples described herein of visually changing a first text based on first feature information may enable a user to intuitively recognize information of a word pronounced by the user. The examples described herein of providing a statistical feature along with a visually changed first text may enable a user to verify general information in addition to transient information of a word pronounced by the user based on the visually changed first text.

The examples described herein of providing, along with a first text of a voice signal, a second text visually changed based on second feature information of a reference voice signal corresponding to the voice signal may enable a user to intuitively recognize an incorrect portion of a word pronounced by the user. The examples described herein of extracting a stammered word from a voice signal based on sets of feature information and determining whether a user has a stammer may enable the user to request a medical diagnosis or treatment before such a condition worsens.

The various elements and methods described above may be implemented using one or more hardware components, one or more software components, or a combination of one or more hardware components and one or more software components.

A hardware component may be, for example, a physical device that physically performs one or more operations, but is not limited thereto. Examples of hardware components include microphones, amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may have various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments for implementing the examples disclosed herein can be easily constructed by a programmer skilled in the art to which the examples pertain based on the drawings and their corresponding descriptions as provided herein.

As a non-exhaustive illustration only, a device described herein may refer to mobile devices such as, for example, a cellular phone, a smart phone, a wearable smart device (such as, for example, a ring, a watch, a pair of glasses, a bracelet, an ankle bracket, a belt, a necklace, an earring, a headband, a helmet, a device embedded in the cloths or the like), a personal computer (PC), a tablet personal computer (tablet), a phablet, a personal digital assistant (PDA), a digital camera, a portable game console, an MP3 player, a portable/personal multimedia player (PMP), a handheld e-book, an ultra mobile personal computer (UMPC), a portable lab-top PC, a global positioning system (GPS) navigation, and devices such as a high definition television (HDTV), an optical disc player, a DVD player, a Blue-ray player, a setup box, or any other device capable of wireless communication or network communication consistent with that disclosed herein. In a non-exhaustive example, the wearable device may be self-mountable on the body of the user, such as, for example, the glasses or the bracelet. In another non-exhaustive example, the wearable device may be mounted on the body of the user through an attaching device, such as, for example, attaching a smart phone or a tablet to the arm of a user using an armband, or hanging the wearable device around the neck of a user using a lanyard.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of providing a user interface (UI), comprising:
generating first feature information indicating a feature of a voice signal;
converting the voice signal to a first text;
visually changing the first text based on the first feature information; and
providing the UI displaying the changed first text.

2. The method of claim 1, wherein:
the first feature information comprises accuracy information of a word in the voice signal; and
the visually changing comprises changing a color of the first text based on the accuracy information.

3. The method of claim 1, wherein:
the first feature information comprises accent information of a word in the voice signal; and
the visually changing comprises changing a thickness of the first text based on the accent information.

4. The method of claim 1, wherein:
the first feature information comprises intonation information of a word in the voice signal; and
the visually changing comprises changing a position at which the first text is displayed based on the intonation information.

5. The method of claim 1, wherein:
the first feature information comprises length information of a word in the voice signal; and
the visually changing comprises changing a spacing of the first text based on the length information.

6. The method of claim 1, further comprising:
segmenting the voice signal based on any one unit of a phoneme, a syllable, a word, a phrase, and a sentence,
wherein the generating comprises generating first feature information indicating a feature of a voice signal obtained by the segmenting, and
wherein the converting comprises converting the voice signal obtained by the segmenting to a first text.

7. The method of claim 1, further comprising:
generating a statistical feature of the first text based on the first feature information and the first text,
wherein the providing comprises providing the UI displaying the statistical feature and the changed first text.

8. The method of claim 1, further comprising:
generating second feature information indicating a feature of a reference voice signal corresponding to the voice signal;
converting the reference voice signal to a second text;
visually changing the second text based on the second feature information; and
providing another UI displaying the changed second text.

9. The method of claim 1, further comprising:
detecting an action corresponding to all or a portion of the first text; and
reproducing a voice signal or a reference voice signal of a first text corresponding to the detected action.

10. A method of providing a user interface (UI), comprising:
segmenting a voice signal into elements;
generating sets of feature information on the elements;
converting the elements to texts;
extracting one or more stammered words from the texts by determining whether the sets of the feature information are repeatedly detected within a preset range;
determining whether a user has a stammer based on a number of the stammered words; and
providing the UI displaying a result of the determining.

11. The method of claim 10, wherein the extracting comprises:
extracting, as the one or more stammered words, a text corresponding to the sets of feature information repeatedly detected within the preset range.

12. The method of claim 10, wherein the determining of whether the user has a stammer comprises:
determining whether the user has a stammer based on a ratio of the number of the stammered words to a number of the texts.

13. A device for providing a user interface (UI), comprising:
a voice recognizer configured to generate first feature information indicating a feature of a voice signal, and convert the voice signal to a first text;
a UI configurer configured to visually change the first text based on the first feature information; and
a UI provider configured to provide the UI displaying the changed first text.

14. The device of claim 13, wherein:
the first feature information comprises accuracy information of a word in the voice signal; and
the UI configurer is configured to change a color of the first text based on the accuracy information.

15. The device of claim 13, wherein:
the first feature information comprises accent information of a word in the voice signal; and
the UI configurer is configured to change a thickness of the first text based on the accent information.

16. The device of claim 13, wherein:
the first feature information comprises intonation information of a word in the voice signal; and
the UI configurer is configured to change a position at which the first text is displayed based on the intonation information.

17. The device of claim 13, wherein:
the first feature information comprises length information of a word in the voice signal; and
the UI configurer is configured to change a spacing of the first text based on the length information.

18. The device of claim 13, wherein the voice recognizer is configured to:
segment the voice signal based on any one unit of a phoneme, a syllable, a word, a phrase, and a sentence;
generate first feature information indicating a feature of a voice signal obtained by the segmenting; and
convert the voice signal obtained by the segmenting to a first text.

19. The device of claim 13, wherein:
the voice recognizer is configured to generate a statistical feature of the first text based on the first feature information and the first text; and
the UI provider is configured to provide the UI displaying the statistical feature and the changed first text.

20. The device of claim 13, wherein:
the voice recognizer is configured to generate second feature information indicating a feature of a reference voice signal corresponding to the voice signal, and convert the reference voice signal to a second text;
the UI configurer is configured to visually change the second text based on the second feature information; and
the UI provider is configured to provide another UI displaying the changed second text.

21. A device for providing a user interface (UI), comprising:
a UI configurer configured to visually change a text converted from a voice signal based on a feature of the voice signal; and
a UI provider configured to provide the UI displaying the changed text.

22. The device of claim 21, wherein the feature comprises an accuracy, an accent, an intonation, or a length of a word in the voice signal.

23. The device of claim 22, wherein the UI provider is configured to:
provide the UI displaying the changed text and a value of the feature.
